(19) United States
(12) Patent Application Publication
(10) Pub. No.: US 2010/0060714 A1
(43) Pub. Date: Mar. 11, 2010

(54) DMB RECEIVING PORTABLE TERMINAL FOR HUMAN BODY COMMUNICATION, DMB TRANSMITTING METHOD THEREOF, AND HMD APPARATUS AND METHOD FOR DMB RECEPTION USING HUMAN BODY COMMUNICATION

(75) Inventors: Sung-Weon Kang, Daejon (KR); Jin-Bong Sung, Daejon (KR); Jung-Hwan Hwang, Daejon (KR); Chang-Hee Hyoung, Daejon (KR); Jin-Kyung Kim, Daejon (KR); Duck-Gun Park, Daejon (KR); Sung-Eun Kim, Seoul (KR); Hyung-Il Park, Daejon (KR); In-Gi Lim, Daejon (KR); Jung-Bum Kim, Daejon (KR); Kyung-Soo Kim, Daejon (KR)

Correspondence Address: AMPACC Law Group, 3500 188th Street S.W., SUITE 103, Lynnwood, WA, 98037, US

(73) Assignee: Electronic and Telecommunications Research Institute, Daejon (KR)

(21) Appl. No.: 12/515,535

(22) PCT Filed: Oct. 31, 2007
(86) PCT No.: PCT/KR07/05435

§ 371 Date: May 19, 2009

(30) Foreign Application Priority Data
Nov. 20, 2006 (KR) 10-2006-0114664
Dec. 6, 2006 (KR) 10-2006-0123350

(51) Int. Cl. H04N 7/14; G09G 5/00; H04N 5/50

(52) U.S. Cl. 348/14.02; 345/8; 348/731; 348/E07.077; 348/E05.097

(57) ABSTRACT

Provided are a DMB receiving portable apparatus for human body communication, a DMB transmitting method thereof, and an HMD apparatus and method for DMB reception using human body communication. The digital multimedia broadcasting (DMB) receiving portable apparatus for human body communication includes: a DMB receiver adapted to perform DMB Rx signal processing on a DMB signal to convert the DMB signal into an audio/video signal, and transmit to a transmission electrode an intermediate frequency (IF) band broadcast signal or a transmission stream (TS) generated in the DMB Rx signal processing; and the transmission electrode adapted to apply the IF band broadcast signal or the TS to the human body as a DMB signal for human body communication.

### TECHNICAL FIELD

The present invention relates to a digital multimedia broadcasting (DMB) receiving portable terminal for human body communication, a DMB transmitting method thereof, and a head mounted display (HMD) apparatus and method for DMB reception using human body communication; and, more particularly, to a DMB receiving portable apparatus for human body communication, which allow a user to conveniently receive DMB services via a user's body without cable or antenna, a DMB transmitting method thereof, and an HMD apparatus and method for DMB reception using human body communication. The DMB receiving portable apparatus connects the portable apparatus with the HMD apparatus by configuring the portable apparatus to send DMB data to the HMD apparatus via the user's body, and configuring the HMD apparatus to process the DMB data received via the user's body and display the DMB data.

This work was supported by the Information Technology (IT) research and development program of the Korean Ministry of Information and Communication (MIC) and/or the Korean Institute for Information Technology Advancement (IITA) [2006-S-072-01, “Controller SoC for Human Body Communications”].

### BACKGROUND ART

Digital multimedia broadcasting (DMB) services are intended to provide a user who is moving in a car or is walking with a variety of multimedia services such as video and various data. The DMB may be categorized into terrestrial DMB and satellite DMB.

As for the terrestrial DMB, a very high frequency (VHF) band signal of approximately 200 MHz band is sent via a broadcasting base station currently being used for analog TV broadcasting, and the signal is received by each user via a user's receiver. There are a variety of types of receivers used for the terrestrial DMB service, such as car receivers, fixed receivers, and portable receiver. Among those receivers, demands are expected to explosively increase, for a portable DMB receiver that is a combination type receiver with a terrestrial DMB-dedicated receiver or a typical portable phone.

To transmit multimedia data of a portable DMB receiver to a head mount display (HMD) apparatus, a wired transmission medium or a wireless transmission medium may be used. If the wired transmission medium is used, users action is limited because of cable connection, which causes inconvenience in use. If the wireless transmission medium is used, an antenna for connecting the DMB receiver with the HMD apparatus is additionally required for the DMB receiver and the HMD apparatus, which deteriorates portability.

### DISCLOSURE OF INVENTION

### Technical Problem

An embodiment of the present invention is directed to providing a DMB receiving portable apparatus for human body communication, a DMB transmitting method thereof, an HMD apparatus and method for DMB reception using human body communication. The DMB receiving portable apparatus allows a user to conveniently receive DMB services via a user's body without a separate cable or antenna, which connect the portable apparatus with the HMD apparatus, by configuring the portable apparatus to send DMB data to the HMD apparatus via the user's body, and configuring the HMD apparatus to process the DMB data received via the user's body and display the DMB data.

Other objects and advantages of the present invention can be understood by the following description, and become apparent with reference to the embodiments of the present invention. Also, it is obvious to those skilled in the art of the present invention that the objects and advantages of the present invention can be realized by the means as claimed and combinations thereof.

### Technical Solution

In accordance with an aspect of the present invention, there is provided a digital multimedia broadcasting (DMB) receiving portable apparatus for human body communication, which includes: a DMB receiver adapted to perform DMB Rx signal processing on a DMB signal to convert the DMB signal into an audio/video signal, and transmit to a transmission electrode an intermediate frequency (IF) band broadcast signal or a transmission stream (TS) generated in the DMB Rx signal processing; and the transmission electrode adapted to apply the IF band broadcast signal or the TS to the human body as a DMB signal for human body communication. The apparatus may further include an output unit adapted to output an audio/video signal converted at the DMB receiver.

In accordance with another aspect of the present invention, there is provided a head mount display device (HMD) for digital multimedia broadcasting (DMB) reception using human body communication, which includes: a reception electrode adapted to receive a DMB signal for human body communication transmitted via a user's body from a DMB receiving portable apparatus; a DMB reception processor adapted to convert the DMB signal for human communication into an audio/video signal through DMB Rx signal processing, and convert the audio/video signal into audio/video data based on an HMD standard; and an HMD processor adapted to reproduce the HMD audio/video data converted at the DMB reception processor.

In accordance with another aspect of the present invention, there is provided a method for transmitting a digital multimedia broadcasting (DMB) signal for human body communication, adapted for a portable apparatus having a DMB reception function, the method which includes the steps of: a) performing DMB Rx signal processing on a radio frequency (RF) band DMB signal received via an antenna to convert the RF band DMB signal into an audio/video signal; and b) applying an intermediate frequency (IF) band broadcast signal or a transmission stream (TS) generated in the DMB Rx signal processing to a user's body, and transmitting the IF band broadcast signal or the TS to a corresponding head mount display (HMD) apparatus.

In accordance with another aspect of the present invention, there is provided a method for digital multimedia broadcasting (DMB) reception, adapted for a head mount display (HMD) apparatus for DMB reception using human body communication, the method which includes the steps of: a) performing DMB Rx signal processing on a DMB signal for human body communication transmitted from a DMB receiving portable apparatus via a user's body to convert the DMB signal for human body communication into an audio/video signal; b) converting the audio/video signal into audio/video data based on an HMD standard; and c) reproducing the audio/video HMD data.

### ADVANTAGEOUS EFFECTS

In according with embodiments of the present invention, a user carrying a portable terrestrial-DMB receiver can view terrestrial DMB broadcasting through an HMD apparatus.

Because a user's body serves as a transmission channel, there is no need to use a separate cable or antenna for connecting the portable terrestrial DMB receiver with the HMD apparatus, and thus user's convenience is improved.

### BRIEF DESCRIPTION OF THE DRAWINGS

FIG. 1 is a view for explaining a method for connecting an HMD apparatus for DMB reception with a user portable apparatus using a human body as a transmission channel in accordance with the present invention.

FIG. 2 is a block diagram of a DMB receiving portable apparatus for human body communication, and an HMD apparatus for DMB reception using human body communication in accordance with a first embodiment of the present invention.

FIG. 3 is a block diagram of a DMB receiving portable apparatus for human body communication, and an HMD apparatus for DMB reception using human body communication in accordance with a second embodiment of the present invention.

### BEST MODE FOR CARRYING OUT THE INVENTION

The advantages, features and aspects of the invention will become apparent from the following description of the embodiments with reference to the accompanying drawings, which is set forth hereinafter. Therefore, those skilled in the field of this art of the present invention can embody the technological concept and scope of the invention easily. In addition, if it is considered that detailed description on a related art may obscure the points of the present invention, the detailed description will not be provided herein. The preferred embodiments of the present invention will be described in detail hereinafter with reference to the attached drawings.

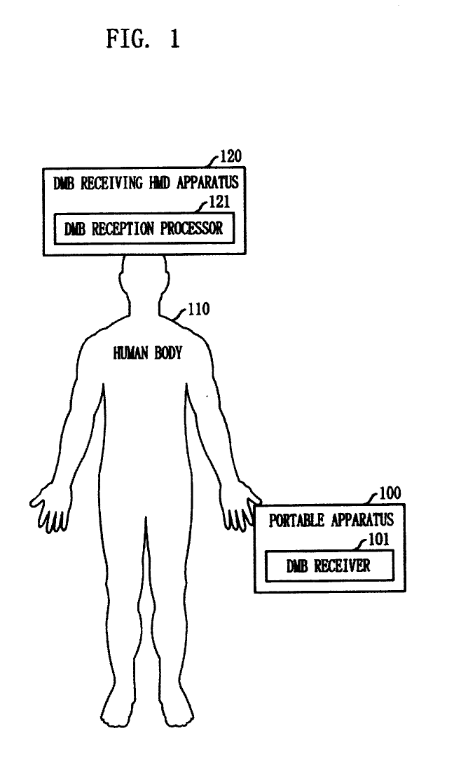

FIG. 1 is a view for explaining a method for connecting an HMD apparatus for DMB reception and a user portable apparatus by using a human body as a transmission channel in accordance with the present invention.

FIG. 1 shows a state in which a DMB receiving portable apparatus 100 (hereinafter, referred to as a user portable apparatus) including a terrestrial DMB receiver 101 is connected with an HMD apparatus 120 for DMB reception (hereinafter, referred to as an HMD apparatus) including a DMB reception processor 121 by using a human body 110 as a transmission channel.

In accordance with the present invention, when the user portable apparatus 100 including the terrestrial DMB receiver 101 transmits multimedia broadcast data via the human body 110, the HMD apparatus 120 receives the multimedia broadcast data via the human body 110, and performs DMB reception processing on the multimedia broadcast data, and displays the broadcast data through the HMD processor.

In accordance with the present invention, a user of the portable apparatus 100 including the terrestrial DMB receiver 101 can view portable terrestrial DMB broadcasting using the HMD apparatus 120.

That is, in accordance with the present invention, the user's body 110 is used as a transmission channel, thereby removing a need for a separate cable or antenna for interconnection of the portable apparatus 100 and the HMD apparatus 120 for transmission of multimedia data.

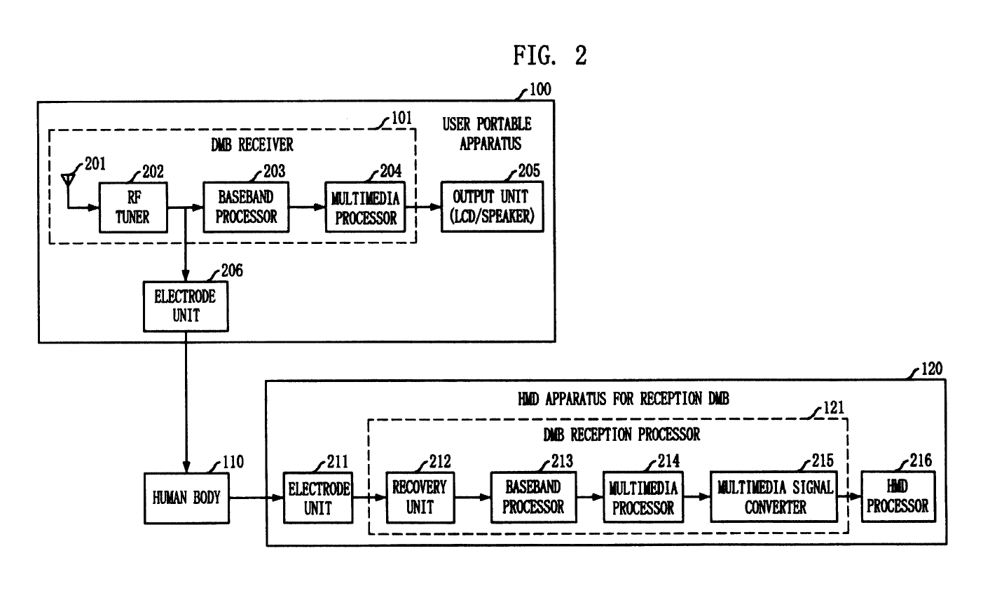

Also, only the transmission medium is changed to the human body without changing the typical portable apparatus 100 including the terrestrial DMB receiver 101 and the typical HMD apparatus, which corresponds to an HMD processor 216 of FIG. 2. For this reason, other functions of the typical portable apparatus 100 and the HMD processor 216 can be used in the same manner.

FIG. 2 is a block diagram of a DMB receiving portable apparatus for human body communication, and an HMD apparatus for DMB reception using human body communication in accordance with a first embodiment of the present invention.

First, the DMB receiving portable apparatus 100, i.e., a user portable apparatus in accordance with the first embodiment of the present invention will now be described.

The user portable apparatus 100 in accordance with the first embodiment of the present invention includes a DMB receiver 101, an output unit 205 such as a liquid crystal display (LCD) and a speaker, and an electrode unit 206, which is a transmission electrode.

The DMB receiver 101 performs DMB Rx signal processing on a DMB signal transmitted over a broadcasting network to convert the DMB signal into an audio/video signal, and transmits an intermediate frequency (IF)-band broadcast signal generated in the DMB Rx signal processing to the electrode unit 206, which is a transmission electrode. In detail, the DMB receiver 101 includes an antenna 201, a radio frequency (RF) tuner 202, a baseband processor 203, and a multimedia processor 204. The DMB receiver 101 of the user portable apparatus 100 receives and processes a broadcast signal from the outside in the same manner as a general DMB receiver.

The DMB signal received via the antenna 201 of the DMB receiver 101, e.g., a terrestrial DMB receiver, and converted into an IF band signal by the RF tuner 202 is applied to the human body 101 through the electrode unit 206, i.e., the transmission electrode. The DMB signal applied to the human body 110 is transmitted to the HMD apparatus 120 via the human body serving as a transmission channel.

The terrestrial DMB signal received via the antenna 201 of the DMB receiver 101 is converted into an IF band signal at the RF tuner 202, and is transmitted to the human body 110 through the electrode unit 206.

The electrode unit 206 contacts the human body 110, and performs impedance matching between the output of the RF tuner 202 and the human body 110. That is, the electrode unit 206, i.e., the transmission electrode, applies an IF band broadcast signal, i.e., a DMB signal for human body communication, to the human body.

The HMD apparatus 120, i.e., an HMD apparatus for DMB reception in accordance with the present invention will now be described.

As shown, the HMD apparatus 120 includes an electrode unit 211, which is a reception electrode, a DMB reception processor 121, and an HMD processor 216.

The DMB reception processor 121 converts an IF band DMB signal, i.e., a DMB signal for human body communication, trough DMB Rx signal processing, and converts the audio/video signal to audio/video data according to an HMD standard. The DMB reception processor 121 includes a recovery unit 212, a baseband processor 213, a multimedia processor 214, and a multimedia signal converter 215.

A signal transmitted to the human body 110 is input to the recovery unit 212 of the DMB reception processor 121 via the electrode unit 211. The electrode unit 211 contacts the human body 110 to perform impedance matching between the human body 110 and the DMB reception processor 121.

The signal having passed through the human body 110 and the electrode unit 211 includes not only a transmission signal output to the electrode unit 211 but also noise and interference caused by the influence of an external electronic device, which may cause signal distortion. Therefore, the recovery unit 212 includes an amplifier, a filter, an analog to digital converter (ADC), or a clock data recovery (CDR) unit.

The data input to the baseband processor 213 is output as a byte stream based on an MPEG-2 TS standard, and is input to the multimedia processor 214. A transmission stream (TS) input to the multimedia processor 214 is converted into an audio signal and a video signal, and is transmitted to the multimedia signal converter 215.

The multimedia signal converter 215 converts the video signal output from the multimedia processor 214 into a video signal based on the HMD standard, and transmits the converted signal to the HMD processor 216. Also, the multimedia signal converter 215 converts a digital audio signal output from the multimedia processor 214 into an analog audio signal, and transmits the converted audio signal to the HMD processor 216. The video/audio signal input to the HMD processor 216 is reproduced through, for example, an LCD and a speaker.

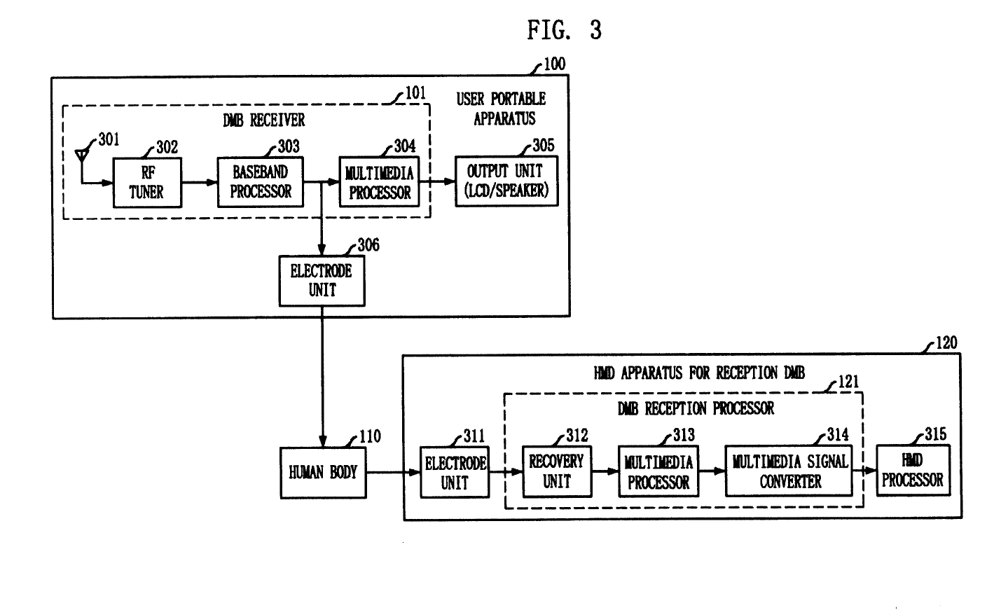

FIG. 3 is a block diagram of a DMB receiving portable apparatus for human body communication, and an HMD apparatus for DMB reception using human body communication in accordance with a second embodiment of the present invention.

A user portable apparatus 100, i.e., a DMB receiving portable apparatus for human body communication in accordance with the second embodiment of the present invention will now be described.

The user portable apparatus 100 in accordance with the second embodiment of the present invention includes a DMB receiver 101, an output unit 305 such as an LCD and a speaker, and an electrode unit 306, which is a transmission electrode.

The DMB receiver 101 performs DMB Rx signal processing on a DMB signal to convert the signal into an audio/video signal. Also, the DMB receiver 101 transmits a transmission stream (TS) generated in the DMB Rx signal processing to the electrode unit 306. In detail, the DMB receiver 101 includes an antenna 301, an RF tuner 302, a baseband processor 303, and a multimedia processor 304. The user portable apparatus 100 shown in FIG. 3 is the same as the user portable apparatus 100 shown in FIG. 2, except that a transmission stream (TS) output from the baseband processor 303 is transmitted via the human body.

Unlike the first embodiment of FIG. 2, in the second embodiment of FIG. 3, a transmission stream (TS) output from the baseband processor 303 of the DMB receiver 101 is transmitted to the HMD apparatus 120 via the human body 110.

A terrestrial DMB signal input via the antenna 301 of the DMB receiver 101 is converted into an IF band signal at the RF tuner 302, and is input to the baseband processor 303. The baseband processor 303 converts the input signal into a byte stream based on the MPEG-2 standard, and then outputs the converted byte stream to the multimedia processor 313 and the electrode unit 306.

The electrode unit 306 contacts the human body to perform impedance matching between the baseband processor 303 and the human body 110, and thus sends the transmission stream (TS) output from the baseband processor 303 to the human body 110. The transmission stream (TS) input to the human body 110 is transmitted to the HMD apparatus 120 through the electrode unit 311.

The HMD apparatus 120, i.e., an HMD apparatus for DMB reception in accordance with the second embodiment of the present invention will now be described.

As shown, the HMD apparatus 120 in accordance with the second embodiment of the present invention includes an electrode unit 311, which is a reception electrode, a DMB reception processor 121, and an HMD processor 315.

The DMB reception processor 121 serves to convert a transmission stream (TS), i.e., a DMB signal for human communication, into an audio/video signal through DMB Rx signal processing, and to convert the audio/video signal into audio/video data based on the HMD standard. The DMB reception processor 121 includes a recovery unit 312, a multimedia processor 313, and a multimedia signal converter 314.

The electrode unit 311 performs impedance matching between the DMB reception processor 121 and the human body 110. The transmission stream (TS) input through the electrode unit 311 is transmitted to the recovery unit 312 for signal recovery.

The recovery unit 312 includes, for example, an amplifier, a filter, an ADC or a CDR unit in order to reduce signal distortion and recover a signal from noise or interference. The transmission stream (TS) transmitted to the multimedia processor 313 is converted into an audio/video signal, and is transmitted to the multimedia signal converter 314.

The multimedia signal converter 314 converts the audio/video signal into an audio/video signal based on the HMD standard, and transmits the converted audio/video signal to the HMD processor 315.

As described above, the technology of the present invention can be realized as a program and stored in a computer-readable recording medium, such as CD-ROM, RAM, ROM, floppy disk, hard disk and magneto-optical disk. Since the process can be easily implemented by those skilled in the art of the present invention, further description will not be provided herein.

The present application contains subject matter related to Korean Patent Application No. 10-2006-0114664 and 10-2006-0123350, filed in the Korean Intellectual Property Office on Nov. 20, 2006, and Dec. 6, 2006, the entire contents of which is incorporated herein by reference.

While the present invention has been described with respect to certain preferred embodiments, it will be apparent to those skilled in the art that various changes and modifications may be made without departing from the scope of the invention as defined in the following claims.

1. A digital multimedia broadcasting (DMB) receiving portable apparatus for human body communication, comprising:
a DMB receiver adapted to perform DMB Rx signal processing on a DMB signal to convert the DMB signal into an audio/video signal, and transmit to a transmission electrode an intermediate frequency (IF) band broadcast signal or a transmission stream (TS) generated in the DMB Rx signal processing; and
the transmission electrode adapted to apply the IF band broadcast signal or the TS to the human body as a DMB signal for human body communication.

2. The apparatus of claim 1, further comprising an output unit adapted to output an audio/video signal converted at the DMB receiver.

3. The apparatus of claim 1, wherein the DMB receiver comprises:
a radio frequency (RF) tuner adapted to convert an RF band DMB signal received via an antenna into an (IF) band DMB signal, and output the converted IF band DMB signal to a baseband processor and the transmission electrode;
the baseband processor adapted to convert the IF band DMB signal into a TS based on a DMB standard; and
a multimedia processor adapted to convert the TS into an audio/video signal.

4. The apparatus of claim 1, wherein the DMB receiver comprises:
a radio frequency (RF) tuner adapted to convert an RF band DMB signal received via an antenna into an IF DMB signal;
a baseband processor adapted to convert the IF band DMB signal into TS based on a DMB standard, and output the TS to a multimedia processor and the transmission electrode; and
the multimedia processor adapted to convert the TS into an audio/video signal.

5. A head mount display device (HMD) for digital multimedia broadcasting (DMB) reception using human body communication, comprising:
a reception electrode adapted to receive a DMB signal for human body communication transmitted via a user's body from a DMB receiving portable apparatus;
a DMB reception processor adapted to convert the DMB signal for human communication into an audio/video signal through DMB Rx signal processing, and convert the audio/video signal into audio/video data based on an HMD standard; and
an HMD processor adapted to reproduce the HMD audio/video data converted at the DMB reception processor.

6. The apparatus of claim 5, wherein the DMB reception processor comprises:
a baseband processor adapted to convert the DMB signal for human body communication received through the reception electrode into a transmission stream (TS) based on a DMB standard, the DMB signal for human body communication being an intermediate frequency (IF) band DMB signal;
a multimedia processor adapted to convert the TS into an audio/video signal; and
a signal converter adapted to convert the audio/video signal into audio/video data based on an HMD standard.

7. The apparatus of claim 5, wherein the DMB reception processor comprises:
a multimedia processor adapted to convert the DMB signal for human body communication transmitted through the reception electrode into an audio/video signal, the DMB signal for human body communication being a transmission stream (TS); and
a signal converter adapted to convert the audio/video signal into audio/video data according to an HMD standard.

8. The apparatus of claim 6, further comprising a recovery unit adapted to correct signal distortion of the DMB signal for human body communication received through the reception electrode.

9. A method for transmitting a digital multimedia broadcasting (DMB) signal for human body communication, adapted for a portable apparatus having a DMB reception function, comprising the steps of:
a) performing DMB Rx signal processing on a radio frequency (RF) band DMB signal received via an antenna to convert the RF band DMB signal into an audio/video signal; and
b) applying an intermediate frequency (IF) band broadcast signal or a transmission stream (TS) generated in the DMB Rx signal processing to a user's body, and transmitting the IF band broadcast signal or the TS to a corresponding head mount display (HMD) apparatus.

10. The method of claim 9, wherein the step a) includes the steps of:
a1) converting the RF band DMB signal into an IF band DMB signal;
a2) converting the IF band DMB signal into a TS based on a DMB standard; and
a3) converting the TS into an audio/video signal.

11. A method for digital multimedia broadcasting (DMB) reception, adapted for a head mount display (HMD) apparatus for DMB reception using human body communication, comprising the steps of:
a) performing DMB Rx signal processing on a DMB signal for human body communication transmitted from a DMB receiving portable apparatus via a user's body to convert the DMB signal for human body communication into an audio/video signal;
b) converting the audio/video signal into audio/video data based on an HMD standard; and
c) reproducing the audio/video HMD data.

12. The method of claim 11, wherein the step a) includes the steps of:
a1) converting an intermediate frequency (IF) band DMB signal for human body communication received through a reception electrode into a transmission stream (TS) based on a DMB standard;
a2) converting the TS into an audio/video signal; and
a3) converting the audio/video signal into audio/video data based on an HMD standard.

13. The method of claim 11, wherein the step of a) includes the steps of:
a1) converting a transmission stream (TS) for human body communication transmitted through a reception electrode into an audio/video signal; and
a2) converting the audio/video signal into audio/video data based on an HMD standard.
